(19) United States
(12) Patent Application Publication
(10) Pub. No.: US 2013/0110846 A1
(43) Pub. Date: May 2, 2013

(54) DATA PROCESSING METHOD AND APPARATUS

(71) Applicants: Zhou Lu, Beijing (CN); Huazhang Yu, Beijing (CN)

(72) Inventors: Zhou Lu, Beijing (CN); Huazhang Yu, Beijing (CN)

(73) Assignee: Feitian Technologies Co., Ltd.

(21) Appl. No.: 13/808,972

(22) PCT Filed: Sep. 21, 2011
(86) PCT No.: PCT/CN2011/079932

§ 371 Date: Jan. 8, 2013

(30) Foreign Application Priority Data
Sep. 26, 2010 (CN) 201010292033.X

(51) Int. Cl. G06F 17/30

(52) U.S. Cl. CPC G06F 17/30312
USPC 707/741

(57) ABSTRACT

The present invention relates to the field of data processing, and specifically to a method and device for data processing. The method comprises: preprocessing an array-to-be-processed; carrying out by means of a predetermined processing method secondary processing on the array-to-be-processed so as to obtain secondary processing results; acquiring an index number from a predetermined place in the secondary processing results; acquiring from the secondary processing results data from predetermined digits on the basis of the index number; converting the acquired data into decimal data; determining whether the bit length of the decimal data is shorter than a second predetermined length; if shorter, adding zeros in front of the high-order bit of the decimal data until reaching the second predetermined length, and regarding the decimal data thereof as processed data; if not shorter, continuously acquiring data from the second predetermined length starting from the low-order bit of the decimal data and regarding said data as processed data. The processing method is simple, and the processed data is irreversible and therefore can be applied to forms of identification.

### FIELD OF THE INVENTION

The invention belongs to data processing field, and more particularly relates to a method for data processing and an apparatus therefor.

### BACKGROUND OF THE INVENTION

Data is a form for expressing fact, concept, or instruction, which can be processed artificially or by an automatic apparatus. The data, which can be in form of number, text, graph, or voice, etc., becomes information after the data is explained and assigned with some meaning. Data processing is collecting, storing, searching, processing, converting, and transferring data, which penetrates social production and respective fields of life. The basic purpose of the data processing is extracting and deducing data which are valuable and meaningful to some specific people from data which are large in quantity and might be disordered and unsystematic.

### SUMMARY OF THE INVENTION

A method for data processing, comprising

preprocessing an array-to-be-processed;

performing secondary processing on the preprocessed array-to-be-processed by using a predetermined processing method to obtain a secondary processing result;

obtaining an index number from a predetermined position of the secondary processing result;

obtaining a predetermined number of bits of data from the secondary processing result according to the index number;

converting the obtained data to decimal data; and

determining whether the bit length of the decimal data is less than a second predetermined length, if yes, make the decimal data reach the second predetermined length by filling zero(s) in front of high order bits and taking the data which reaches the second predetermined length by filling zero(s) in front of high order bits as processed data; otherwise, taking data of the second predetermined length which is taken from low order bit of the decimal data consecutively as the processed data.

Preprocessing the array-to-be-processed comprises

converting the array-to-be-processed to a hexadecimal data array;

determining whether the length of the array-to-be-processed which is obtained by converting is less than a first predetermined length, if yes, filling the array-to-be-processed which is obtained by converting to reach the first predetermined length;

connecting the content of the array-to-be-processed which is obtained by filling.

Filling the array-to-be-processed which is obtained by converting to reach the first predetermined length comprises filling zero(s) from the right side of the array-to-be-processed which is obtained by converting to reach the first predetermined length.

Connecting the content of the array-to-be-processed which is obtained by filling comprises connecting the content of an array-to-be-processed to the end of a previous array-to-be-processed.

Performing secondary processing on the preprocessed array-to-be-processed by using a predetermined processing method to obtain a secondary processing result comprises performing secondary processing on the preprocessed array-to-be-processed by using the predetermined processing method according to a predetermined secret to obtain the secondary processing result.

Performing secondary processing on the preprocessed array-to-be-processed by using a predetermined processing method according to a predetermined secret to obtain the secondary processing result comprises

Step 1, filling 0 from the right side of the predetermined secret to make the predetermined secret reach a specific length;

Step 2, performing xor operation on the connecting result of step 1 and a first specific data;

Step 3, connecting the content of preprocessed array-to-be-processed to the end of the operation result of Step 2;

Step 4, processing the connecting result of Step 3 by using the predetermined processing method;

Step 5, performing xor operation on the connecting result of Step 1 and a second specific data;

Step 6, connecting the operation result of Step 4 to the end of the operation result of Step 5;

Step 7, processing the connecting result of Step 6 by using the predetermined processing method to obtain the secondary processing result.

Before Step 1, the method further comprises when the length of the predetermined secret is longer than the specific length, processing the predetermined secret by using the predetermined processing method.

The first specific data and the second specific data is predetermined and determined by the predetermined processing method.

The predetermined processing method is collision-free and one-way processing method, which comprises fingerprint algorithm or encryption hash algorithm.

Obtaining the index number from a predetermined position of the secondary processing result further comprises

taking out a predetermined number of bits from the predetermined position of the secondary processing result and determining whether the decimal data corresponding to the bits taken out overpasses the length of the secondary processing result, if yes, performing remainder operation on the length of the secondary processing result by using the decimal data corresponding to the bits taken out and taking an obtained remainder as the index number.

Obtaining a predetermined number of bits of data from the secondary processing result according to the index number comprises

taking a predetermined number of bits of data consecutively from the position, which is corresponding to the index number, of the secondary processing result;

or

obtaining bit number of arithmetic shift right by computing the index number according to a predetermined formula;

performing arithmetic shift right on the secondary processing result according to the bit number of arithmetic shift right;

obtaining a predetermined number of bits of data consecutively from low order bit of the secondary processing result after the right shift.

The predetermined formula is BITS=128−LBS4*8, wherein BITS represents arithmetic shift right bit number, and LSB4 represents the index number.

An apparatus of data processing, comprising:

a preprocessing unit configured to preprocess an array-to-be-processed and output the preprocessed array-to-be-processed to a secondary processing unit;

the secondary processing unit configured to perform secondary processing on the preprocessed array-to-be-processed by using a predetermined processing method to obtain a secondary processing result and output the secondary processing result to a first obtaining unit;

the first obtaining unit configured to obtain an index number from a predetermined position of the secondary processing result and output the index number to a second obtaining unit;

a second obtaining unit configured to obtain a predetermined number of bit of data from the secondary processing result according to the index number and output the data of predetermined bit number to a converting unit;

the converting unit configured to convert the data of predetermined bit number to decimal data and output the decimal data to a determining unit;

the determining unit configured to determine whether the bit number of the decimal data is less than a second predetermined length and output the determining result and the decimal data to an output unit;

the output unit configured to, when the bit number of the decimal data is not less than the second predetermined length, take the data of the second predetermined length consecutively from the low order bit of the decimal data as processed data and output the processed data; when the bit number of the decimal data is less than the second predetermined length, make the decimal data reach the second predetermined length by filling zero(s) in front of high order bits and take the data which is filled zero(s) in front of high order bits as the processed data and output the processed data.

The preprocessing unit comprises

a first converting module configured to convert the array-to-be-processed to decimal data array and output the converted array-to-be-processed to a first determining module;

the first determining module configured to determine whether the length of the array-to-be-processed which is obtained by converting of the first converting module reaches a first predetermined length;

a filling module configured to fill 0 from the right side of the array-to-be-processed which is obtained by converting of the first converting module to reach the first predetermined length;

a combining module configured to connect the content of the array-to-be-processed which is obtained by filling of the filling module.

Connecting the content of the array-to-be-processed which is obtained by filling of the filling module comprises connecting the content of an array-to-be-processed which is obtained by filling to the end of a previous array-to-be-processed.

The secondary processing unit comprises

a storing module configured to store a first specific data and a second specific data;

a preprocessing module configured to process a predetermined secret to obtain the predetermined secret with specific length;

a first computing module configure to perform xor operation on the predetermined secret with the specific length which is generated by the preprocessing module and the first specific data;

a first filling module configured to connect the content of the array-to-be-processed, which is processed by the preprocessing module, to the end of the operation result of the first computing module;

a second computing module configured to perform operation on the connecting result of the first filling module by using the predetermined processing method;

a third computing module configured to perform xor operation on the predetermined secret with specific length, which is generated by the preprocessing module, and the second specific data;

a second filling module configured to connect the operation result of the second computing module to the end of the operation result of the third computing module;

a fourth computing module configured to compute the connecting result of the second filling module by using the preprocessing method to obtain a secondary processing result.

The secondary processing unit further comprises

a determining module configured to determine whether the length of the predetermined secret is longer than a specific length;

a processing module configured to, when the determining result of the determining module is yes, process the predetermined secret with which the length is longer than the specific length by using a predetermined processing method.

The preprocessing method is collision-free and one-way algorithm, which comprises fingerprint algorithm or encryption hash algorithm.

The second obtaining unit comprises

a second determining module configured to determine whether the received index number overpasses the length of the secondary processing result;

a second converting module configured to, when the determining result of the second determining module is yes, convert the index number to a value which is less than the length of the secondary processing result.

Converting the index number to a value which is less than the length of the secondary processing result comprises performing remainder operation on the length of the secondary processing by using the decimal data corresponding to the bits taken out and taking the remainder as the index number.

The second obtaining unit further comprises

a computing unit configured to compute bit number of arithmetic shift right of the secondary processing result according to the index number;

a right shift module configured to perform arithmetic shift right on the secondary processing result according to the bit number of arithmetic shift right;

a third obtaining module configured to obtain data of a predetermined number of bits from low order bit of the secondary processing result after arithmetic shift right.

The predetermined formula is BITS=128−LBS4*8, wherein BITS represents arithmetic shift right bit number and LBS4 represents the index number.

Advantages: The method for processing data can integrate and process a set of data or a plurality of sets of data in different length or format in order to generate data with a fixed length and a fixed format. The generated data has features of good randomness and irreversibly processing, which can be applied in identity verification field.

### BRIEF DESCRIPTION OF THE DRAWINGS

FIG. 1 is a flow chart of a method for data processing provided by Embodiment 1 of the present invention; and

FIG. 2 is a block diagram of an apparatus of data processing provided by Embodiment 2 of the present invention.

### DETAILED DESCRIPTION OF THE INVENTION

In order to make the object, technical solution, and advantages clearer, the following is detailed description for the embodiments of the present invention in conjunction with the accompanying drawings.

### Embodiment 1

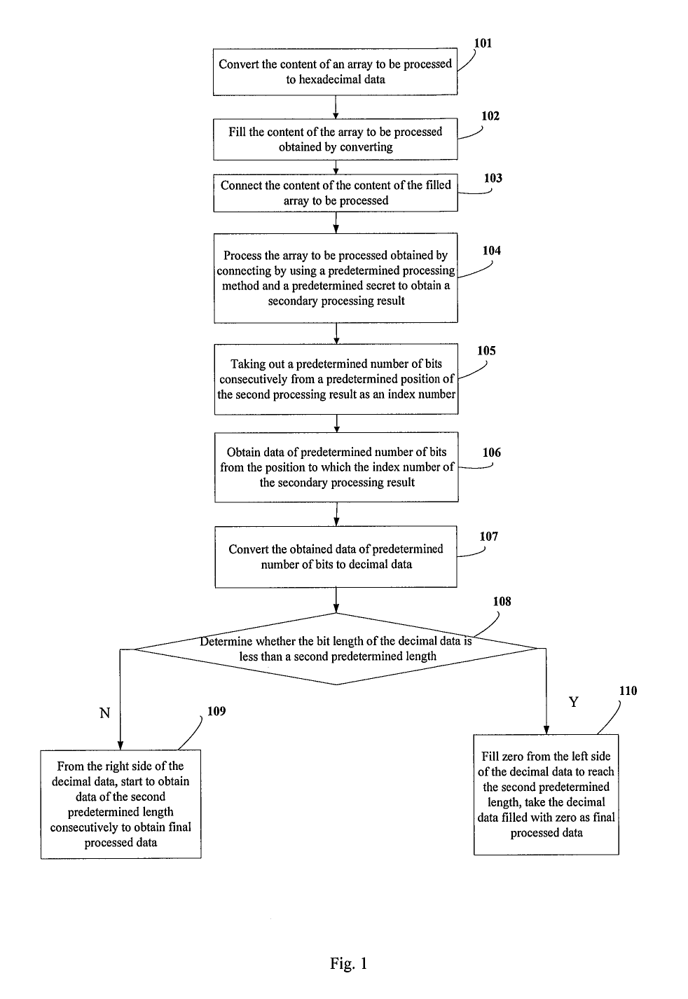

The present embodiment provides a method for data processing. Referring to FIG. 1, the method is described in detail as follows.

101, convert the content of an array-to-be-processed to hexadecimal data;

In the present embodiment, a first array and a second array which are to be processed are taken as an example for illustration. In this case, the first array is a character array C1[ ]={‘1’, ‘2’, ‘3’, ‘4’, ‘5’, ‘6’, ‘7’, ‘8’}; the content of the first array is converted to decimal data of “12345678” ; then the decimal data is converted to a hexadecimal data array so as to obtain the first array which is C1[ ]={OxBC, Ox61, Ox4E}; the second array is C2={Ox5A, Ox83, Ox15, Ox23, Ox91, OxB0, Ox67, Ox45, OxE0, Ox90, Ox1A, OxA4, OxAF, Ox31, Ox5C, OxC3, Ox20, Ox56, Ox51, Ox6B}, which is hexadecimal data; therefore, no converting is required here. Preferably, the data mentioned in the present embodiment is stored in form of BIG-ENDIAN (the most significant byte is stored at low address).

102, fill the content of the array-to-be-processed which is obtained by converting;

Specifically, determine whether the length of the array-to-be-processed which is obtained by converting is less than a first predetermined length, if yes, fill the content of the array-to-be-processed which is obtained by converting;

Specifically, fill 0 from the right side of the array-to-be-processed which is obtained by converting till the length of the array reaches the first predetermined length.

Specifically, the first predetermined length is 128;

In the embodiment, in Step 102, the lengths of the first array and second array, which are obtained by converting, are 3 and 20 respectively. Both of the lengths are less than 128; fill 125 “00” and 108 “00” from the right side respectively of the first array and second array which are obtained by converting so as to obtain the filled first array C1[ ]={OxBC, Ox61, Ox4E, 125 of Ox00}and the filled second array C2[ ]={Ox5A, Ox83, Ox15, Ox23, Ox91, OxB0, Ox67, Ox45, OxE0, Ox90, Ox1A, OxA4, OxAF, Ox31, Ox5C, OxC3, Ox20, Ox56, Ox51, Ox6B, 108 of Ox00};

103, connect the content of the filled arrays to be processed;

Specifically, connecting the content of the filled array-to-be-processed refers to connecting content of a filled array-to-be-processed obtained to the end of a previous filled array-to-be-processed;

For example, the content of the filled second array C2[ ]is connected to the first array C1[ ] so as to obtain the array after connecting C1[ ]={OxBC, Ox61, Ox4E, 125 of Ox00, Ox5A, Ox83, Ox15, Ox23, Ox91, OxB0, Ox67, Ox45, OxE0, Ox90, Ox1A, OxA4, OxAF, Ox31, Ox5C, OxC3, Ox20, Ox56, Ox51, Ox6B, 108 of Ox00};

At the time of implementing program, function strcat(c1,c2) is used to realize connecting the content of the second array C2to the first array C1.

104, process the array-to-be-processed which is obtained by connecting by using a predetermined processing method according to a predetermined secret to obtain a secondary processing result;

Specifically, the predetermined processing method is a collision-free and one-way processing method, which includes fingerprint algorithm or security harsh algorithm.

It should be noted that processing the array-to-be-processed, which is obtained by connecting, by using the predetermined processing method according to the predetermined secret further requires two additional fixed and different hexadecimal data. The two additional fixed and different hexadecimal data is determined by the used predetermined processing method and identified by ipad and opad. For example, if the predetermined processing method is the security hash algorithm HMAC-sha1, ipad is “Ox36”, and opad is “Ox5C”.

Specifically, the predetermined processing method is identified by H, the predetermined secret is identified by array K. The content of array K is hexadecimal data and the array-to-be-processed obtained by connecting is identified by text; then the process of processing the array-to-be-processed, which is obtained by connecting, by using the predetermined processing method according to a predetermined secret to obtain the secondary processing result is as follows:

Step 1, fill 0 from the right side of K to create an array with length of B (For example, if the length of K is 20 and B=64, 44 “0×00” are added from the right side of K);

Step 2, perform xor operation on the content of the array, which is created by Step 1, and ipad;

Step 3, connect the content of text to the end of the operation result of Step 2;

Step 4, use H to process the connecting result obtained by Step 3;

Step 5, perform xor operation on the content of the array created by Step 1 and opad;

Step 6, connect the processing result of Step 4 to the end of the operation result of Step 5; and

Step 7, use H to process the connecting result obtained by Step 6 so as to obtain the secondary processing result.

The connecting method is identical to the connecting method described in 103; no more detail is given here.

Specifically, in practice, the array-to-be-processed can be taken as the predetermined secret. For example, if there are a first array, a second array and a third array which are the arrays to be processed, the first array-to-be-processed and the second array-to-be-processed can be processed by the method described by Step 101 to Step 103 and the third array-to-be-processed which is processed by Step 101 is taken as K and used in Step 104.

The present step further includes predetermining whether length of the predetermined secret is longer than a specified length, if the length of the predetermined secret is longer than the specified length, process the predetermine secret by using a predetermined processing method.

For example, after processing the connecting result of Step 103 by using the above 7 steps, the obtained secondary processing result is C[ ]={Ox1f, Ox86, Ox98, Ox69, Ox0E, Ox02, OxCA, Ox16, Ox61, Ox50, OxEF, OxEF, Ox19, OxDA, Ox8E, Ox94, Ox5B, Ox55, Ox5a, Ox09} and the content of the secondary processing result is

“Ox1f8698690E02CA166150EFEF19DA8E945B555a09”.

105, take a predetermined number of bits consecutively from a predetermined position of the secondary processing result as an index number;

Specifically, the predetermined position can be the last byte or the first byte of the secondary processing result. In addition, if the length of the secondary processing result is known, the predetermined position can be any byte in the secondary processing result, for example, the middle position of the secondary processing result.

In the present embodiment, low four bits, which are taken out from the last byte of the secondary processing result, are taken as the index number; of course, the last byte can be taken as the index number as well;

Further, the present step further includes determining whether the index number overpasses the length of the secondary processing result, which assures that the obtained index number will not cross border so as to avoid error happening.

Specifically, determining whether the index number overpasses the length of secondary processing result includes converting the obtained index number to decimal data; comparing the length of the decimal data with that of the secondary processing result, if the length of the decimal data overpasses that of the secondary processing result, the index number is regarded as crossing border; then the index number is converted to a value which is less than the value of the length of the secondary processing result, performing remainder operation on the secondary processing result after converting the index number to decimal data, taking the remainder obtained by operation as the index number; specifically, the operation includes converting the index number to decimal data and dividing the decimal data by the length of the secondary processing result to obtain the remainder and taking the remainder as the index number; or taking the value, which is obtained by the decimal data corresponding to the index number minus the integer multiple of the length of the secondary processing result, as the index number.

For example, take the low four bits “Ox9” of the last byte “Ox09” in the secondary processing result “Ox1f8698690E02CA166150EFEF19DA8E945B555a09” obtained by Step 104 as the index number, that is, the obtained index number is 9.

106, obtain a predetermined number of bits of data from the position pointed by the index number of the secondary processing result;

Specifically, the secondary processing result is numbered from 0 according to bytes; then a position, which is corresponding to the index number, in the numbered secondary processing result is found; and the predetermined number of bits of data is obtained consecutively from the position.

Specifically, the step further includes converting the obtained data of the predetermined number of bits to an integer without symbol or big endian.

For example, take 32 bits of data from the secondary processing result and number the secondary processing result obtained by Step S104 to obtain

| 0 | 1 | 2 | 3 | 4 | 5 | 6 | 7 | 8 | 9 | 10 | 11 | 12 | 13 | 14 | 15 | 16 | 17 | 18 | 19 |
|---|---|---|---|---|---|---|---|---|---|---|---|---|---|---|---|---|---|---|---|
| 1f | 86 | 98 | 69 | 0E | 02 | CA | 16 | 61 | 50 | EF | 7F | 19 | DA | 8E | 94 | 5B | 55 | 5a | 09 |

Hereby, the offset pointer obtained by Step 105 is 9; four bytes of data “Ox50EF7F19” is taken from a byte numbered 9; for example, convert the obtained “Ox50EF7F19” to an integer without symbol or big endian; the first byte is masked by “Ox7F” to obtain “Ox50EF7F19”.

107, convert the obtained data of the predetermined number of bits to decimal data;

108, determine whether the bit length of the decimal data is less than a second predetermined length, if the bit length is less than the second predetermined length, go to Step 109; otherwise, go to Step 110;

109, obtain the data of the second predetermined length consecutively from the low order bit of the decimal data to obtain the final processed data;

110, make the decimal data reach the second predetermined length by filling zero(s) in front of high order bits and take the decimal data obtained by filling zero(s) as the final processed data.

For example, when the second predetermined length is 9, take 9 numbers consecutively from the low order bit of the decimal data 1357872921 to obtain the final processed data 357872921.

For example, when the second predetermined length is 11, fill one 0 in front of the high order bit of the decimal data 1357872921 to make the decimal data 1357872921 reach the second predetermined length so as to obtain the final processed data 01357872921.

Further, after Step 109 or Step 110, the method further includes computing CRC (cyclic redundancy check) code of the obtained data of the second predetermined length and obtaining new data by appending the CRC code, which is obtained by computing, to the end of the data of the second predetermined length; the data with the CRC code is taken as the final processed data.

For example, computing the CRC checksum of the data 357872921 with the second predetermined length: 10−((5+8+5+2+9+2+2)mod10=7; append the checksum 7 to the end of 357872921 to obtain 3578729217 and take 3578729217 as obtained final processing data.

Specifically, in implementing, Step 107 to Step 110 can be processed as follows:

107′, convert the obtained data of the predetermined number of bits to hexadecimal data;

108′, determine whether the length of the hexadecimal data is less than the second predetermined length, if yes, go to Step 109′; otherwise go to Step 110′;

109′, consecutively obtain the data with the second predetermined length from the low order bit of the hexadecimal data so as to obtain the final processed data.

110′, make the hexadecimal data reach the second predetermined length by filling zero(s) from high order bits and take the hexadecimal data obtained by filling zero(s) as the final processed data.

For example, if the second predetermined length is 6, take 6 bits consecutively from the low order bit of the hexadecimal data 50EF7F19, which is obtained by converting, to obtain EF7F19; EF7F19 is taken as the result of final processing.

In such a way, the form of the final processed data can be diversified, which includes forms of letter+number, number or letters.

It should be noted that some changes can be made on the processing flow above, however expected effect can be achieved as well, for example, Step 106 can be replaced by the following steps:

106-1, calculate the index number according to a predetermined formula to obtain arithmetic shift right bit number;

Specifically, the predetermined formula can use, but not limited to, BITS=128−LBS4*8; in this case, BITS represents arithmetic shift right bit number and LBS4 represents the index number.

106-2, perform arithmetic shift right on the secondary processing result according to the arithmetic shift right bit number;

Perform arithmetic shift right on the secondary processing result “Ox1f8698690E02CA166150EFEF19DA8E945B555a09” by 56 bits, in order to obtain “Ox1f8698690E02CA166150EFEF19”.

106-3, obtain data of predetermined number of bits consecutively from the low order bit of the secondary processing result after the arithmetic shift right.

Take data of the predetermined number of bits consecutively from the low order bit of “Ox1f8698690E02CA166150EFEF19” obtained after arithmetic shift right. For example, if the predetermined bit number is 32, the obtained data of the predetermined number of bits is “Ox5OEFEF19”. Subsequent executing process is identical to the Step 107 to Step 110 and no more detail is given here.

The method for processing data can integrate and process a set of data or a plurality of sets of data in different length or format in order to generate data with a fixed length and a fixed format. The generated data has the features of good randomness and irreversibly processing, which can be applied in an identity verifying field.

### Embodiment 2

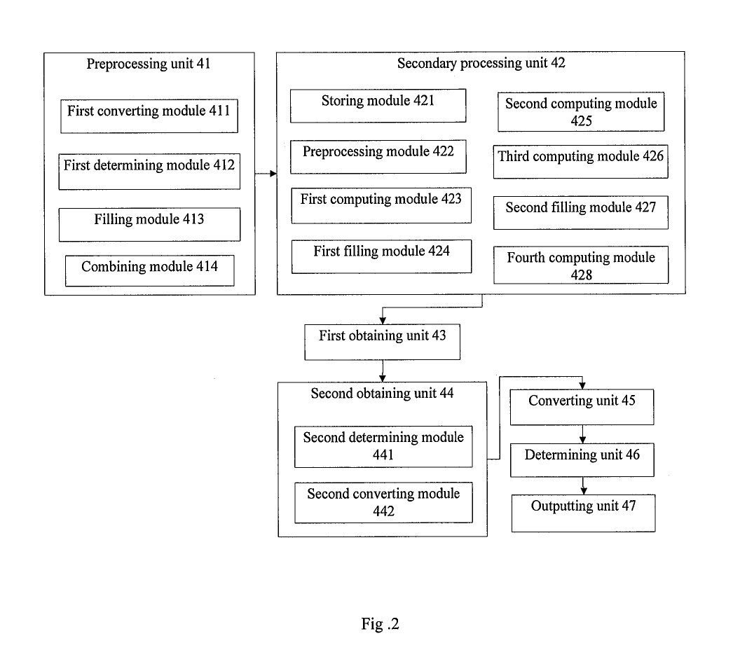

Referring to FIG. 2, the present embodiment 2 provides an apparatus for data processing which includes a pre-processing unit 41, a secondary processing unit 42, a first obtaining unit 43, a second obtaining unit 44, a converting unit 45, a determining unit 46, and an outputting unit 47. The functions of respective units are as follows.

The preprocessing unit 41 is configured to preprocess an array-to-be-processed and output the preprocessed array-to-be-processed to the secondary processing unit 42.

The secondary processing unit 42 is configured to process the array-to-be-processed which has been preprocessed according to a predetermined processing method to obtain a secondary processing result and output the secondary processing result to the first obtaining unit 43.

The first obtaining unit 43 is configured to take a predetermined number of bits from a predetermine position of the received secondary processing result as an index number and output the index number to the second obtaining unit 44; the predetermined position includes the first byte of the secondary processing result, any byte in the secondary processing result or the last byte of the secondary processing result.

The second obtaining unit 44 is configured to obtain a predetermined number of bits of data from the position corresponding to the index number of the secondary processing result and output the obtained data of predetermined number of bits to the converting unit 45.

The converting unit 45 is configured to convert the received data of the predetermined number of bits to decimal data and output the decimal data obtained by converting to the determining unit 46.

The determining unit 46 is configured to determine whether the bit length of the received decimal data is less than the second predetermined length and output the determining result and the decimal data to the outputting unit 47.

The outputting unit 47 is configured to, when the bit length of the decimal data is not less than the second predetermined length, take data of the second predetermined length, which is taken consecutively from the low order bit of the decimal data, as the processed data; when the bit length of the decimal data is less than the second predetermined length, make the decimal data reach the second predetermined length by filling zero(s) from high order bits and take the data which is filled zero(s) from the high order bits as the processed data.

Specifically, the preprocessing unit 41 includes a first converting module 411, a first determining module 412, a filling module 413, and a combining module 414;

In this case, the first converting module 411 is configured to convert the content in the array-to-be-processed to the decimal data and convert the decimal data obtained by converting to hexadecimal data array and output the converted array-to-be-processed to the first determining module 412.

The first determining module 412 is configured to determine whether the length of the received array-to-be-processed, which is obtained by the converting of the converting module 411, reaches the first predetermined length, if the determining result is no, output the hexadecimal data to the filling module 413.

The filling module 413 is configured to fill zero(s) from the right side of the received array-to-be-processed, which is obtained by converting of the converting module 411, to reach the first predetermined length and output the filled array-to-be-processed to the combining module 414.

The combining module 414 is configured to connect the content of the received array-to-be-processed which is obtained by filling of the filling module and output the connecting result to the secondary processing unit 42.

Connecting the content of the array-to-be-processed obtained by filling means connecting content of an array-to-be-processed obtained by filling to a previous array-to-be-processed by filling.

Specifically, the secondary processing unit 42 includes

a storing module 421 configured to store first specific data and a second specific data;

a preprocessing module 422 configured to process a predetermined secret to obtain the predetermined secret with specific length;

a first computing module 423 configured to perform xor operation on the predetermined secret with the specific length, which is generated by the preprocessing module 422, and first specific data;

a first filling module 424 configured to connect the content of the array-to-be-processed which is processed by the preprocessing unit 41 after the computing result of the first computing module 423;

a second computing module 425 configured to compute the connecting result of the first filling module 424 by using a predetermined processing method;

a third computing module 426 configured to perform xor operation on the predetermined secret and specific length, which is generated by the preprocessing module 421, and the second specific data; and

the second filling module 427 configured to connect the computing result of the second computing module 425 to the end of the computing result of the third computing result 426;

the fourth computing module 428 configured to process the connecting result of the second filing module 427 by using a predetermined processing method to obtain the secondary processing result.

Specifically, the secondary processing unit 42 further includes

a determining module 429 configured to determine whether the length of the predetermined secret is longer than a specific length; and

a processing module 420 configured to, when the determining result of the determining module 429 is yes, process the predetermined secret which is longer than the specified length.

Specifically, the predetermined processing method is a collision-free and one-way processing method, which includes fingerprint algorithm or security harsh algorithm.

Specifically, the second obtaining unit 44 includes a second determining module 441 and a second converting module 442;

in which the second determining module 441 is configured to determine whether the received index number overpasses the length of the secondary processing result; and

the second converting module 442 is configured to convert the index number to a value which is not greater than the length value of the secondary processing result; specifically, covert the index number to decimal data and then perform remainder operation on the secondary processing result and take the remainder obtained by computing as the index number; the computing method specifically includes dividing the decimal data corresponding to the taken bits by the length of the secondary processing result to obtain a remainder and taking the remainder as the index number; or taking a value, which is obtained by the decimal number corresponding to the taken bits minus the integer multiple of the length of the secondary processing result, as the index number.

Specifically, the second obtaining unit 44 further includes a computing module, a right shifting module and a third obtaining module;

in which, the computing module is configured to compute arithmetic shift right bit number of the secondary processing result according to the index number;

the right shifting module is configured to perform arithmetic shift right on the secondary processing result according to the arithmetic shift right bit number, which is obtained by computing of the computing module, to obtain the secondary processing result after the arithmetic shift right; and

the third obtaining module is configured to obtain a predetermined number of bits of data from the low order bits of the secondary processing result after the arithmetic shift right.

In this case, a predetermined formula is BITS=128−LBS4*8; BITS represents arithmetic shift right bit number, and LBS4 represents the index number.

The presently disclosed preferred embodiments should be considered in all respects to be illustrative and not restrictive. The scope of the invention is indicated by the appended claims rather than the foregoing description, and all variations which come within the meaning and range of equivalents thereof are intended to be embraced therein.

1. A method for data processing, wherein said method comprises
preprocessing an array-to-be-processed;
performing secondary processing on the pre-processed array-to-be-processed by using a predetermined processing method so as to obtain a secondary processing result;
obtaining an index number from a predetermined position of the secondary processing result;
obtaining a predetermined number of bits of data from the secondary processing result according to the index number;
converting the obtained data to decimal data; and
determining whether the bit length of the decimal data is less than a second predetermined length, if yes, making the decimal data reach the second predetermined length by filling zero(s) in front of high order bits and taking the data which reaches the second predetermined length by filling zero(s) in front of high order bits as processed data; otherwise, consecutively taking data of the second predetermined length from low order bits of the decimal data as the processed data.

2. The method of claim 1, wherein said pre-processing the array-to-be-processed comprises
converting the array-to-be-processed to a hexadecimal data array;
determining whether the length of the array-to-be-processed which is obtained by converting is less than a first predetermined length, if yes, filling the array-to-be-processed which is obtained by converting to reach the first predetermined length; and
connecting the content of the array-to-be-processed which is obtained by filling.

3. The method of claim 2, wherein said filling the array-to-be-processed which is obtained by converting to reach the first predetermined length comprises filling zero(s) from the right side of the array-to-be-processed which is obtained by converting to reach the first predetermined length.

4. The method of claim 2, wherein said connecting the content of the array-to-be-processed which is obtained by filling comprises connecting the content of an array-to-be-processed to the end of a previous array-to-be-processed.

5. The method of claim 1, wherein said performing secondary processing on the pre-processed array-to-be-processed by using a predetermined processing method so as to obtain a secondary processing result comprises performing a secondary processing on the preprocessed array-to-be-processed by using the predetermined processing method according to a predetermined secret so as to obtain the secondary processing result.

6. The method of claim 5, wherein said performing secondary processing on the preprocessed array-to-be-processed by using a predetermined processing method according to a predetermined secret so as to obtain the secondary processing result comprises
Step 1, filling 0 from the right side of the predetermined secret to make the predetermined secret reach a specific length;
Step 2, performing xor operation on the connecting result of Step 1 and first specific data;
Step 3, connecting the content of said pre-processed array-to-be-processed to the end of the operation result of Step 2;
Step 4, processing the connecting result of Step 3 by using the predetermined processing method;
Step 5, performing xor operation on the connecting result of Step 1 and second specific data;
Step 6, connecting the operation result of Step 4 to the end of the operation result of Step 5;
Step 7, processing the connecting result of Step 6 by using the predetermined processing method so as to obtain the secondary processing result.

7. The method of claim 6, wherein before Step 1, the method further comprises when the length of the predetermined secret is longer than a specific length, processing the predetermined secret by using the predetermined processing method.

8. The method of claim 6, wherein the first specific data and the second specific data are predetermined, and determined by the predetermined processing method.

9. The method of claim 1, wherein the predetermined processing method is collision-free and one-way processing method, which comprises fingerprint algorithm or encryption hash algorithm.

10. The method of claim 1, wherein said obtaining the index number from a predetermined position of the secondary processing result further comprises
taking out a predetermined number of bits from the predetermined position of the secondary processing result, and determining whether the decimal data corresponding to the bits taken out overpasses the length of the secondary processing result, if yes, performing remainder operation on the length of the secondary processing result by using the decimal data corresponding to the bits taken out, and taking an obtained remainder as the index number.

11. The method of claim 1, wherein said obtaining a predetermined number of bits of data from the secondary processing result according to the index number comprises
consecutively taking a predetermined number of bits of data from the secondary processing result at a position corresponding to the index number;
or
obtaining bit number of arithmetic shift right by computing the index number according to a predetermined formula;
performing arithmetic shift right on the secondary processing result according to the bit number of arithmetic shift right; and
consecutively obtaining a predetermined number of bits of data from low order bits of the secondary processing result after the right shift.

12. An apparatus of data processing, wherein said apparatus comprises:
a preprocessing unit configured to pre-process an array-to-be-processed, and output the preprocessed array-to-be-processed to a secondary processing unit;
the secondary processing unit configured to perform secondary processing on the preprocessed array-to-be-processed by using a predetermined processing method so as to obtain a secondary processing result, and output the secondary processing result to a first obtaining unit;
the first obtaining unit configured to obtain an index number from a predetermined position of the secondary processing result, and output the index number to a second obtaining unit;
the second obtaining unit configured to obtain data of predetermined bit number from the secondary processing result according to the index number, and output the data of predetermined bit number to a converting unit;
the converting unit configured to convert the data of predetermined bit number to decimal data, and output the decimal data to a determining unit;
the determining unit configured to determine whether the bit number of the decimal data is less than a second predetermined length, and output the determining result and the decimal data to an output unit; and
the output unit configured to, when the bit number of the decimal data is not less than the second predetermined length, consecutively take the data of the second predetermined length from the low order bits of the decimal data as processed data, and output the processed data; while, when the bit number of the decimal data is less than the second predetermined length, make the decimal data reach the second predetermined length by filling zero(s) in front of high order bits, and take the data which is filled with zero(s) in front of high order bits as the processed data, and output the processed data.

13. The apparatus of claim 12, wherein the preprocessing unit comprises
a first converting module configured to convert the array-to-be-processed to hexadecimal data array, and output the converted array-to-be-processed to a first determining module;
the first determining module configured to determine whether the length of the array-to-be-processed which is obtained by converting of the first converting module reaches a first predetermined length;
a filling module configured to fill 0 from the right side of the array-to-be-processed which is obtained by converting of the first converting module so as to reach the first predetermined length; and
a combining module configured to connect the content of the array-to-be-processed which is obtained by filling of the filling module.

14. The apparatus of claim 13, wherein said connecting the content of the array-to-be-processed which is obtained by filling of the filling module comprises connecting the content of the array-to-be-processed which is obtained by filling to the end of a previous array-to-be-processed.

15. The apparatus of claim 12, wherein the secondary processing unit comprises
a storing module configured to store first specific data and second specific data;
a preprocessing module configured to process a predetermined secret so as to obtain the predetermined secret with specific length;
a first computing module configured to perform xor operation on the predetermined secret with the specific length which is generated by the preprocessing module and the first specific data;
a first filling module configured to connect the content of the array-to-be-processed, which is processed by the preprocessing module, to the end of the operation result of the first computing module;
a second computing module configured to perform operation on the connecting result of the first filling module by using the predetermined processing method;
a third computing module configured to perform xor operation on the predetermined secret with specific length, which is generated by the preprocessing module, and the second specific data;
a second filling module configured to connect the operation result of the second computing module to the end of the operation result of the third computing module; and
a fourth computing module configured to compute the connecting result of the second filling module by using the preprocessing method so as to obtain a secondary processing result.

16. The method of claim 15, wherein the secondary processing unit further comprises
a determining module configured to determine whether the length of the predetermined secret is longer than a specific length; and
a processing module configured to, when the determining result of the determining module is yes, process the predetermined secret with specific length by using the predetermined processing method.

17. The apparatus of claim 12, wherein the preprocessing method is collision-free and one-way algorithm, which comprises fingerprint algorithm or encryption hash algorithm.

18. The apparatus of claim 12, wherein the second obtaining unit comprises
a second determining module configured to determine whether the received index number overpasses the length of the secondary processing result; and
a second converting module configured to, when the determining result of the second determining module is yes, convert the index number to a value which is less than the length of the secondary processing result.

19. The apparatus of claim 18, wherein said converting the index number to a value which is less than the length of the secondary processing result comprises performing remainder operation on the length of the secondary processing by using the decimal data corresponding to the bits taken out, and take the remainder as the index number.

20. The apparatus of claim 12, wherein the second obtaining unit further comprises
a computing unit configured to compute bit number of arithmetic shift right of the secondary processing result according to the index number;
a right shift module configured to perform arithmetic shift right on the secondary processing result according to the bit number of arithmetic shift right; and
a third obtaining module configured to obtain data of a predetermined number of bits from low order bits of the secondary processing result after arithmetic shift right.
